(19) United States
(12) Patent Application Publication
(10) Pub. No.: US 2013/0101002 A1
(43) Pub. Date: Apr. 25, 2013

(54) METHOD OF DISPLAYING A DIGITAL SIGNAL

(71) Applicants: Adam M. GETTINGS, Palo Alto, CA (US); Andrew G. STEVENS, Palo Alto, CA (US)

(72) Inventors: Adam M. GETTINGS, Palo Alto, CA (US); Andrew G. STEVENS, Palo Alto, CA (US)

(73) Assignee: RoboteX, Inc., Palo Alto, CA (US)

(21) Appl. No.: 13/597,212

(22) Filed: Aug. 28, 2012

Related U.S. Application Data
(60) Provisional application No. 61/550,745, filed on Oct. 24, 2011.

(51) Int. Cl. H04B 17/00; H04N 7/26

(52) U.S. Cl. 375/224; 375/240.02; 375/E07.138

(57) ABSTRACT

Devices communicate with one another over a wireless channel according to a signal strength of a signal transmitted over the wireless channel. Digital data captured at a source is transmitted over the wireless channel at a first quality if the signal strength or latency is above a threshold and at a second quality if the signal strength or latency is below the threshold. In addition, noise can be inserted into the transmitted digital data as a way to alert the recipient of the signal of signal strength degradation at a finer granularity.

### CROSS-REFERENCE TO RELATED APPLICATION(S)

This application claims the benefit of U.S. provisional patent application entitled “Method of Displaying a Digital Signal,” filed on Oct. 24, 2011, having application Ser. No. 61/550,745, which is incorporated herein by reference.

### BACKGROUND

This disclosure relates in general to wireless communication systems and methods, and more specifically to a new and useful system and method for displaying a digital signal.

Operators of communication devices can be distracted from their communications if they are constantly monitoring for signal strength. As an example, when an operator controls a robot with a remote controller, the operator may need to monitor signal strength, but this can divert the operator's attention and affect the operator's focus on the precise operation and control of the robot.

### SUMMARY

Embodiments disclosed herein adjust the data rate or the quality of data being sent over a wireless channel in response to a detection of reduced signal strength over the channel, and can also improve latency. A system according to one embodiment includes a first communication device and a second communication device configured to communicate with one another over a wireless channel, and a signal strength detection module configured to detect a signal strength of a signal transmitted over the wireless channel, wherein the second communication device is configured to send digital data of a first quality to the first communication device if the signal strength is above a threshold and to send digital data of a second quality to the first communication device if the signal strength is below the threshold, the second quality being lower than the first quality. A system according to another embodiment includes a first communication device and a second communication device configured to communicate with one another over a wireless channel, and a signal strength detection module configured to detect a signal strength of a signal transmitted over the wireless channel, wherein the second communication device is configured to insert noise into digital data to be transmitted to the first communication device, and the amount of noise inserted into the digital data is based in part on the signal strength.

A system according to another embodiment includes a first communication device and a second communication device configured to communicate with one another over a wireless channel, wherein at least one of the communication devices is configured to detect a latency of a signal transmitted over the wireless channel, and the second communication device is configured to send digital data of a first quality to the first communication device if the latency is above a threshold and to send digital data of a second quality to the first communication device if the latency is below the threshold, the first quality being lower than the second quality.

A method of adjusting a quality of digital data transmitted over a wireless channel according to a signal strength of a signal transmitted over the wireless channel includes the steps of capturing digital data with a recording device and transmitting digital data representative of the captured digital data over a wireless channel for reproduction by an output device, the transmitted digital data being of a first quality if the signal strength is above a threshold and of a second quality if the signal strength is below the threshold.

A method of altering digital video data captured at a source and transmitting the altered digital video data to a destination over a wireless channel according to a signal strength of a signal transmitted over the wireless channel includes the steps of inserting noise into the digital video data captured at the source according to the signal strength, wherein an increased amount of noise is inserted if the signal strength decreases and a decreased amount of noise is inserted if the signal strength increases, and transmitting the digital video data having the noise inserted therein to the destination.

Numerous technical advantages are provided according to various embodiments of the present disclosure. Particular embodiments of the disclosure may exhibit none, some, or all of the advantages depending on the implementation.

Other technical advantages of the present disclosure will be readily apparent to one skilled in the art from the following figures, descriptions, and claims. Moreover, while specific advantages are enumerated, various embodiments may include all, some, or none of the enumerated advantages.

### BRIEF DESCRIPTION OF THE DRAWINGS

So that the manner in which the above recited features of the present disclosure can be understood in detail, a more particular description of the present disclosure, briefly summarized above, may be had by reference to embodiments, some of which are illustrated in the appended drawings. It is to be noted, however, that the appended drawings illustrate only typical embodiments of the present disclosure and are therefore not to be considered limiting of its scope, for the present disclosure may admit to other equally effective embodiments.

FIG. 1 illustrates the perceived quality of a video transmission plotted against signal strength for both analog and digital video.

FIG. 2 illustrates the perceived quality of a video transmission plotted against signal strength for analog video and multiple bit rates of digital video.

FIG. 3 illustrates a robot and controller system according to one embodiment.

FIG. 4 illustrates how the resolution of an image can be reduced to alert a user of decreasing signal strength.

FIG. 5 illustrates the amount of noise artifacts introduced into a digital video signal in relation to signal strength.

FIG. 6 illustrates sample digital video frames that have varying amounts of noise artifacts introduced therein.

FIG. 7 illustrates sample digital video frames that have varying amounts of noise artifacts introduced into a portion thereof.

FIG. 8 illustrates the amount of noise artifacts introduced into digital video signals of different bit rates in relation to signal strength.

FIG. 9 is a flowchart that illustrates a method of displaying a digital signal according to one embodiment.

FIG. 10 is a flowchart that illustrates a method of displaying a digital signal according to another embodiment.

### DETAILED DESCRIPTION

In the following description, numerous specific details are set forth to provide a more thorough understanding of embodiments of the disclosure. However, it will be apparent to one of skill in the art that embodiments may be practiced without one or more of these specific details. In other instances, well-known features have not been described in order to avoid obscuring embodiments of the present disclosure.

A receiver that receives an analog signal will notice an increase in noise as signal strength decreases. A decrease in signal strength could be caused by an increase in the distance between a transmitter and the receiver or by interference on a communication channel established between the transmitter and the receiver. The analog signal will degrade as the noise slowly overcomes the signal. A user monitoring the signal (e.g., watching video transmitted wirelessly) will be able to do so until it becomes so faint that it is completely washed out by the noise. For digital signals, digital signal processing (DSP) technology may apply filters, transforms, error correction, compression, and other techniques to improve signal-to-noise ratio and maintain a steady data rate as the noise level changes. However, this can cause a sudden drop-off (or cut-off) of the data rate to zero when the digital signal is overcome by noise. A user monitoring a digital video transmission will see a high quality image, and then when the signal is overcome with noise, the image will disappear completely and suddenly. To overcome this, certain embodiments disclosed herein intentionally reduce the data rate of the digital transmission as noise increases or signal strength decreases so that the received signal appears to slowly degrade, much like an analog signal, which also can preserve latency of the signal. For applications requiring low latency, the data rate can be reduced in order to preserve a certain latency, such that a signal is transmitted at a lower quality but with less latency, or as little latency as possible. This reduced data rate can also allow for bandwidth to be preserved for transmitting other information. In some embodiments, other characteristics of the transmission may be adjusted to further signal the user, such as color resolution. In other embodiments, noise artifacts can be introduced in inverse proportion to the signal strength to provide the user an indication of signal strength. In other embodiments, noise artifacts can be introduced in proportion to latency to provide the user an indication of latency.

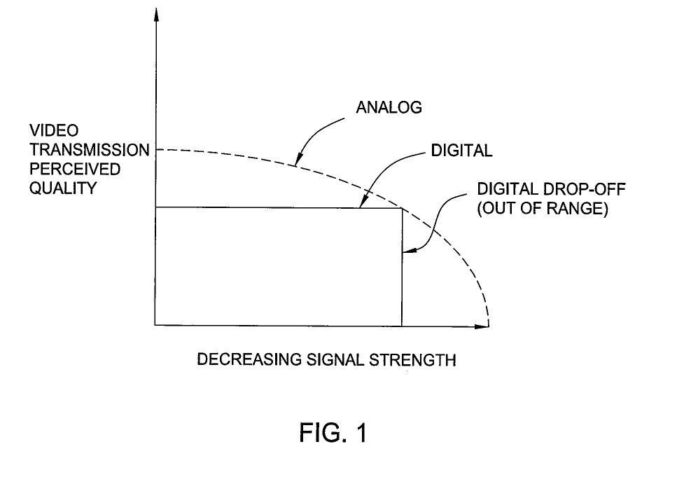

FIG. 1 illustrates the perceived quality of a video transmission plotted against signal strength for both analog and digital video. Although the figure describes video signals, similar effects can be observed for audio signals, control signals, or any other communication signal. As shown, analog video decays gradually until it reaches a point where it becomes unusable, whereas digital video can maintain a certain quality and then drop off abruptly, often without warning to the user monitoring the transmission.

In certain applications, the “digital drop-off” can lead to unfortunate results. As one example, a law enforcement officer outside a building may be using a robot containing a video camera and a robot controller to inspect the interior of the building. As the robot navigates various hallways and rooms in the building, the number of walls and other obstructions between the controller and the robot might increase, which in turn can increase the noise in the video signal. With an analog video signal, the officer can see the video quality gradually decreasing as noise increases. The officer may want to take appropriate actions to prevent the loss of the signal entirely; e.g., by reversing the path of the robot and returning it closer to the officer. With a digital video signal, the officer may not notice any degradation in video signal quality until the digital drop-off occurs. When this occurs, the lack of a video signal from the robot can make it difficult or impossible for the officer to direct the robot to a location where communication can be re-established. A lower latency signal would also enable officers to, react or respond better or faster to situations they may encounter. Other applications requiring low latency can be any application where remote operation requires human control, such as robots in space, surgical robots, remote controlled robots like the RoboteX avatar system, or any other suitable application. Embodiments of the present disclosure intentionally decrease the data rate and thus the potential reproduction quality of the video signal as noise increases so that the user of the system, through the degradation of the video quality, is warned of the potential drop-off of the signal. Adjusting the data rate can also reserve bandwidth for other wireless communications besides the video signal, such as control signals. Certain embodiments may decrease the data rate or other determinants of quality to lower the latency of a signal. As latency improves, the data rate of the signal may be increased so that a higher quality signal is transmitted.

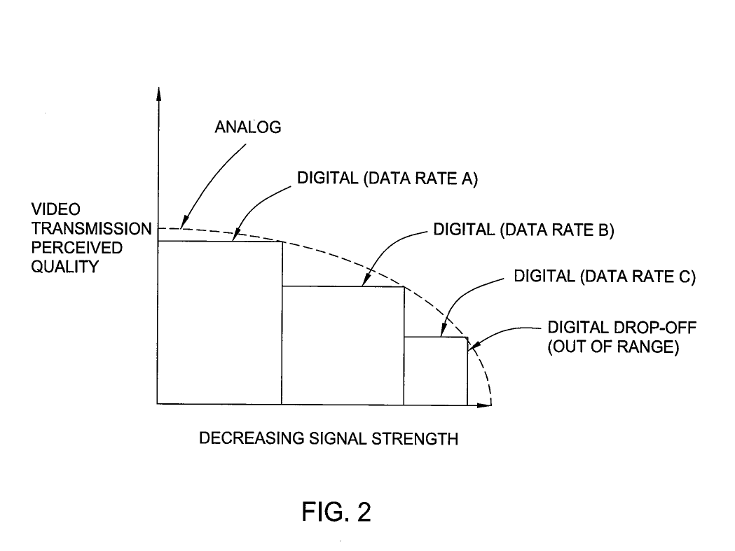

In FIG. 2, the perceived quality of a video transmission is plotted against signal strength for analog video and multiple bit rates of digital video. As signal strength decreases, the data rate for the digital signal is lowered to lower the video quality, which visually alerts the user that signal strength is decreasing and also can reserve bandwidth for non-video communications in some embodiments. In FIG. 2, data rate A is shown to be higher than data rate B, and both are shown to be higher than data rate C. A higher data rate will generally correspond with a higher quality of video transmission. Any number of different data rates can be used in various embodiments. A larger number of data rates allows for more levels of video quality that can be used to alert the user of the signal strength. It is worth noting that the latency can be better preserved at the lower data rates.

In some embodiments, a lower bit rate may show up as pixelation in a digital video frame. The viewer can use the level of pixelation to approximate signal strength and make appropriate decisions. In other embodiments, color depth and/or color palette (referred to herein as “color resolution”) can be adjusted to communicate to the viewer that the signal strength is decreasing. The viewer of the video signal will notice the color adjustments and that will serve as a warning that the signal strength is decreasing, and that the signal may be in danger of being lost completely.

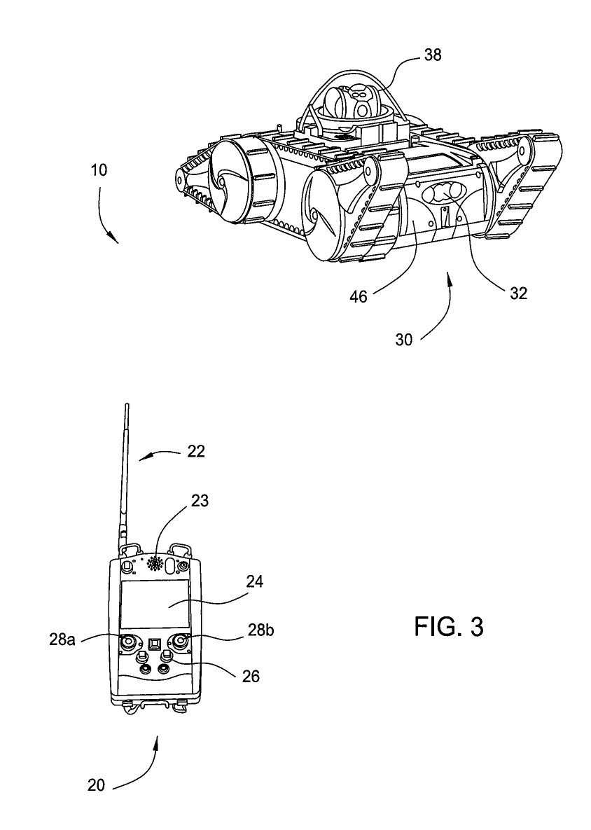

FIG. 3 illustrates a robot and controller system 10 configured to implement embodiments of the present disclosure. System 10 comprises a controller 20 and a robotic system 30. Controller 20 may comprise any type of controller for communicating wirelessly with robotic system 30. In one example embodiment, controller 20 comprises a controller for a RoboteX Avatar® II robot. Controller 20 includes an antenna 22 for wireless communication that is configured to send and receive data, including video data, audio data, and control data for robotic system 30, and a signal strength detector (or signal strength detection module). Controller 20 may have one or more antennas 22 and a signal strength detector for each antenna, and the antennas may be external or internal antennas. Controller 20 also includes a display 24. Display 24 may be any type of display or output device, including a touch-screen display. Display 24 may also support split screen viewing of multiple camera systems, which would allow for a single controller 20 to control more than one controlled device simultaneously. The display also allows controller 20 to display multiple video feeds from a single robotic system 30. As shown, controller 20 includes a number of buttons 26 used to perform various operations and operate various features on the controlled device, one or more joysticks 28, such as joysticks 28a and 28b, for controlling movement of robotic system 30 or for controlling accessories associated with robotic system 30, such as cameras or manipulator arms, and a two-way speaker/microphone 23 for communicating remotely with people, animals, objects, etc., at or near robotic system 30.

Controller 20 also includes a number of internal components (not shown) for providing functionality in system 10, such as one or more computer processing chips configured to perform functions associated with system 10, one or more memory modules for storing data, a GPS or other location detecting module, and hardware for accessing cellular networks for sending and/or receiving voice or data. Controller 20 further includes any number of audio or video components for sending, receiving, displaying, outputting, or processing audio or video data, and hardware and/or software operable to communicate over a wireless channel. Controller 20 may also include hardware, software, or a combination of hardware and software to measure the latency of a signal sent over the wireless channel. In one embodiment, signal strength is measured (using any known hardware or techniques) and used to derive a latency measurement. In another embodiment, robotic system 30 sends beacon messages to controller 20, which controller 20 bounces back. The time between the transmission and receipt of these messages can be used to calculate latency.

In one example, the robot persistently sends beacon messages to the controller. The controller bounces the messages back, and the time between these events (T) is measured. This value is then used to calculate an average latency (L) as follows:

L′=(w*T)+((1−w)*L).

In the formula, L′ is the updated latency and L is the previous latency. The initial value of L for the first iteration is 0. Also, w represents a weighting factor. In one implementation, the value of w that is used is different depending on whether T is greater than L or not. When T>L, weighting factor w1 is used. When T<=L, weighting factor w2 is used. In this embodiment, w1>w2. The weighting factor is used so that the average latency is pulled up quicker than it is pulled down. The purpose of this is to dampen oscillations that can occur with the dynamic quality adjustment (since adjusting the quality of the video can affect the latency measurement).

FIG. 3 also illustrates robotic device 30 for use in system 10. In one example embodiment, robotic device 30 comprises a RoboteX Avatar® II robot. Robotic device 30 comprises a front-mounted drive camera 32 and a 360-degree camera 38 for capturing video. In addition, robotic device 30 comprises audio speakers 46 and a microphone (not shown).

In this example embodiment, robotic device 30 collects video via camera 32 or camera 38 and transmits it wirelessly to controller 20, where a user can view the video on display 24. Audio and other data can also be collected and transmitted wirelessly. Controller 20 monitors the strength of the signal received from robotic system 30 using the signal strength detector. In some embodiments, controller 20 may monitor the latency of the signal instead of, or in addition to, monitoring signal strength. Upon receipt of the signal and determining its signal strength (and/or measuring the latency of the signal), controller 20 communicates the signal strength to robotic device 30, and robotic device 30 in response thereto adjusts the data rate of the video signal being transmitted wirelessly to controller 20 as described above in conjunction with FIG. 2. The lower data rate for video can improve the latency of the signal (e.g. improve the average latency and reduce latency jitter), and can also allow some bandwidth to be reserved for other wireless data transmissions from robotic device 30 to controller 20.

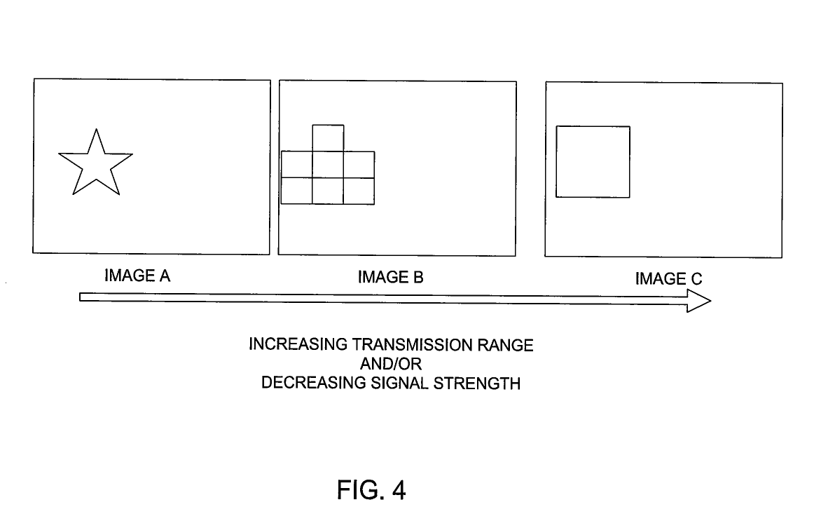

FIG. 4 illustrates how the resolution of an image can be reduced to alert a user of decreasing signal strength. The three images shown in FIG. 4 represent example screenshots of video received and displayed on display 24. Image A is the first example image, and it shows a star being generated from a video signal that is transmitted at a high data rate. Image B is the second example image, and it shows the star being displayed from a video signal that is transmitted at a lower data rate than the data rate of a video signal that generated Image A. As shown, the lower data rate of the transmission has created a pixelated image of the star in Image B. The third example image is Image C. The video signal that generated Image C is transmitted at a lower data rate than the data rate of the video signal that generated Image B. As shown, Image C is a block that is roughly the same size of the star in Image A and in roughly the same location, but it is otherwise of a low quality. Movement of the objects in Image A, Image B, or Image C can occur with approximately the same latency. If a user were controlling a device, the user would recognize the movement and be able to respond quickly to the movement due to the reduced latencies achieved by transmitting reduced resolution images. Thus the functionality of the system can be preserved with lower latencies.

It should be recognized that a reduced resolution image can provide other advantages for a user of the system. A reduced resolution image can be used by an operator of a robot to navigate around obstacles or make decisions in a stressful or dangerous situation, where a low resolution image is better than no image at all. The reduced resolution image can also preserve bandwidth to be allocated for other communications, such as navigation instructions from the controller to the robot. The reduced resolution image can be accompanied by a lower latency to allow for greater functionality of the system.

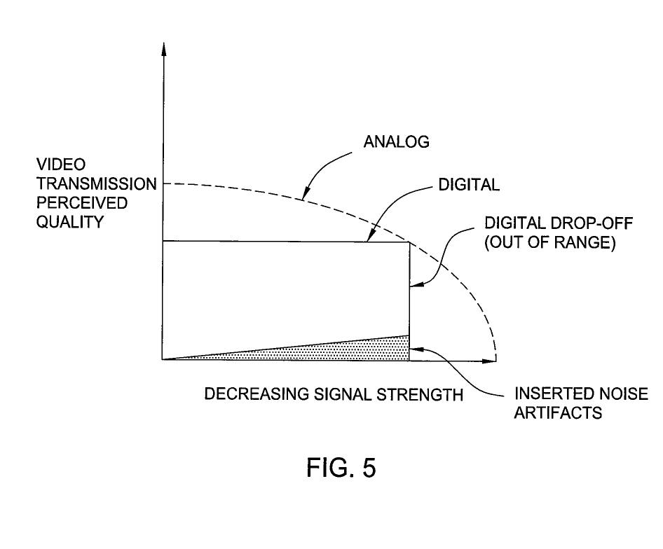

FIG. 5 illustrates the amount of noise artifacts introduced into a digital video signal in relation to signal strength. Although the figure describes video data, similar effects can be observed for audio signals. As noted above, analog video decays gradually until it reaches a point where it becomes unusable, whereas digital video can maintain a certain quality and then drop off abruptly, often without warning to the user monitoring the transmission. In the embodiment corresponding to FIG. 5, noise (or noise artifacts) is inserted into a digital signal being transmitted to visually warn the recipient of the signal, through corresponding degradation in the reproduced video, that the transmission may be in danger of being cut off due to the digital drop-off This inserted noise can subtly notify the user that the signal strength is decreasing, and the user can take appropriate actions before reaching the digital drop-off This process emulates (for a digital signal) the effect of decreasing signal strength on an analog signal.

As seen in FIG. 5, increasing levels of noise are inserted in a manner that is inversely proportional to signal strength. That is, as signal strength decreases, the amount of noise inserted increases. Conversely, as signal strength increases, the amount of noise inserted decreases.

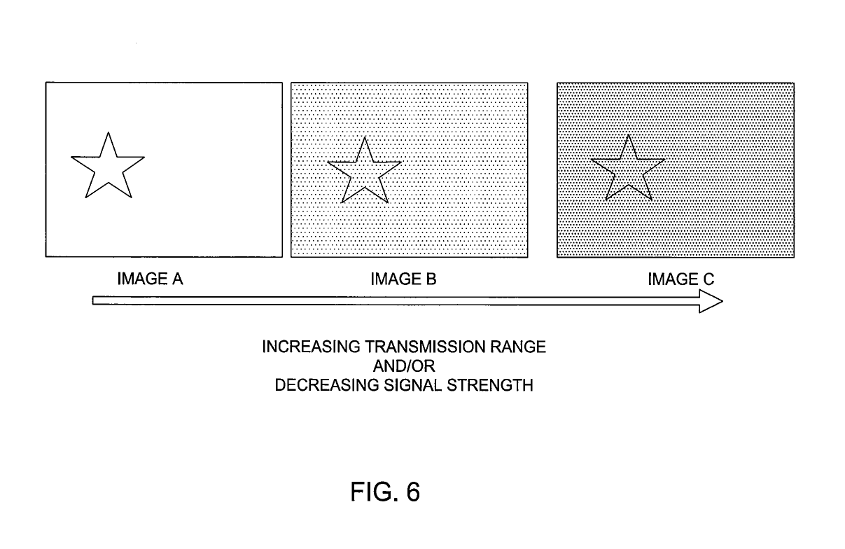

FIG. 6 illustrates sample digital video frames or images that have varying amounts of noise artifacts introduced therein. These digital video frames represent example screenshots of video received and displayed on display 24. In this figure, noise artifacts are introduced to affect the quality of the entire image frame. Image A represents a digital video frame without inserted noise artifacts. Images B and C represent digital video frames with noise artifacts inserted, with fewer noise artifacts inserted in the digital video frame of Image B.

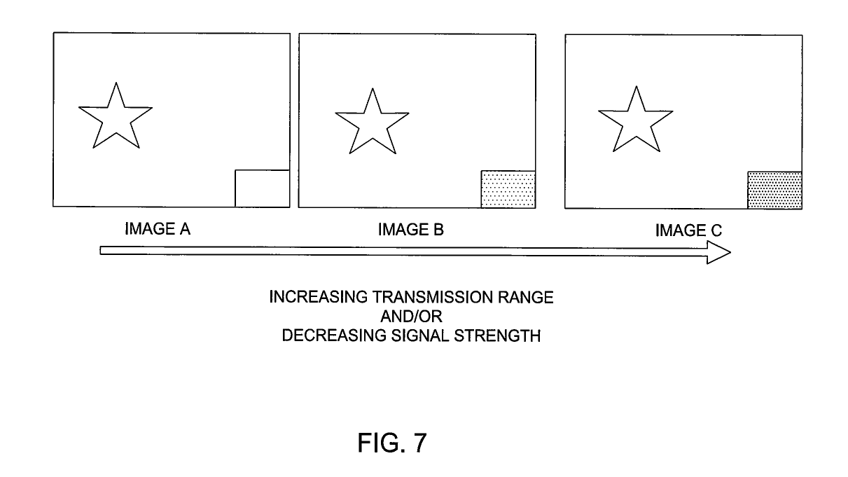

FIG. 7 illustrates sample digital video frames that have varying amounts of noise artifacts introduced into a portion thereof. Image A represents a digital video frame without any noise artifacts inserted. Image B and Image C represent digital video frames with noise artifacts inserted into a bottom right corner thereof, with fewer noise artifacts inserted in the digital video frame of Image B. In this example, the noise is not inserted into the entire image frame but instead it is inserted into a portion of the frame. Inserting the noise into the corner of the image or in another non-intrusive location allows the user to see most of the image without noise while still being able to monitor the signal strength via the visually perceived noise level in the corner of the image.

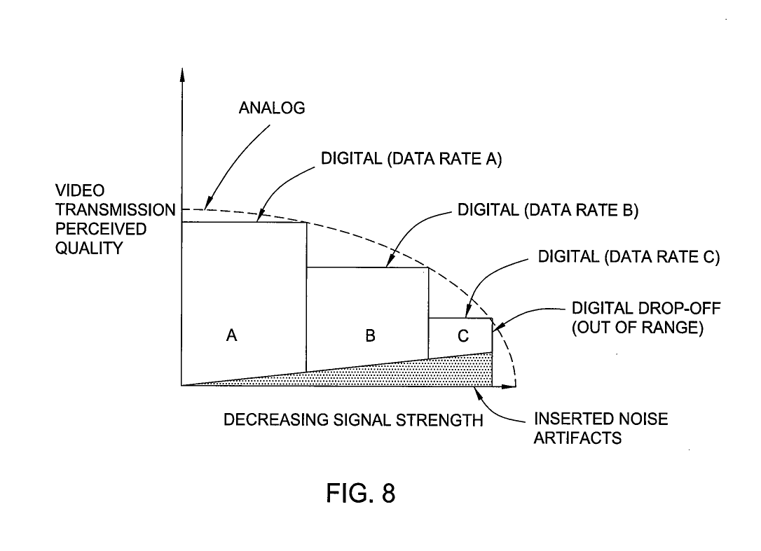

FIG. 8 illustrates the amount of noise artifacts introduced into digital video signals of different bit rates in relation to signal strength. As signal strength decreases, the data rate for the digital video signal is lowered to lower the video quality, which visually alerts the user that signal strength is decreasing, and reserve bandwidth for non-video communications. In FIG. 8, data rate A is higher than data rate B, and both are higher than data rate C. In addition to lowering data rates, noise artifacts are introduced into a digital video signal in relation to signal strength to alert the user that signal strength is decreasing at a finer granularity. For example, the insertion of noise artifacts will alert the user of signal strength increase or decrease at all points within region A, at all points within region B, and at all points within region C, and not just across region boundaries.

In another example embodiment, a portion of the data can be transmitted at a high quality and a portion can be transmitted at a lower quality. This embodiment could be useful in a variety of situations. For example, the transmission range for video data may have increased and that would necessitate a lower data rate for the video being transmitted. However, one portion of the video image being transmitted may be more important than the rest of the image. The more important portions can be transmitted with a higher data rate or data quality, and the other portions could be transmitted with a lower data rate or data quality. As one example, a police officer may be using a remote video system for surveillance inside a building. The officer may be viewing a criminal suspect and would like to receive a higher quality transmission of the suspect's face, and be willing to accept a lower quality transmission of the other parts of the image, such as the background of the image. This system could initiate appropriate video capture and processing to transmit a portion of the video showing the suspect's face at a high resolution and the rest of the video at a lower resolution.

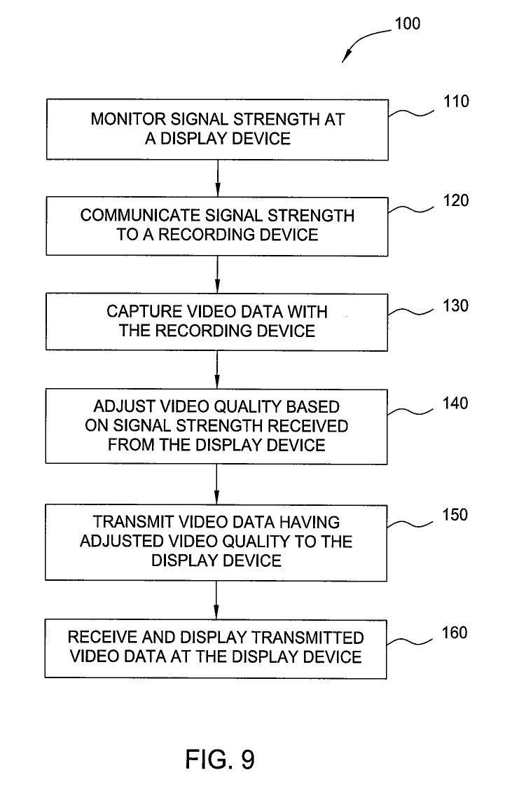

FIG. 9 is a flowchart that illustrates a method 100 of displaying a digital signal according to one embodiment. In particular, the illustrated method reduces the quality of transmitted digital video data when a reduction in the strength of the signal containing the transmitted digital video data is detected. Reducing the quality of digital video data can serve as an indicator to the viewer of the video that the reduction in the strength of the signal containing the transmitted digital video data has occurred, while also minimizing any perceived latency of the signal. Perceived latency can include signal latency and/or data packet drop rate. The steps illustrated in FIG. 9 may be combined, modified, or deleted where appropriate. Additional steps may also be added to the example operation. Furthermore, the described steps may be performed in any suitable order.

Method 100 begins with Step 110. In Step 110, signal strength is measured or monitored at a display device using any appropriate signal strength detector. In the embodiment illustrated herein, the display device is part of a wireless controller configured to control a mobile device that captures video and transmits the captured video back to the wireless controller for display using the display device. In other embodiments, the display device may be a part of a mobile or desktop computing device configured to control the mobile device. The signal strength that is measured may include transmission power or bandwidth latency.

In Step 120, the measured signal strength is communicated to a recording device, which may include a video camera. One example is the RoboteX Avatar® II robot, which is able to capture video with a front-mounted drive camera or a 360-degree camera. In Step 130, video data is captured with the recording device at the native resolution of the recording device. The captured video data is stored in any appropriate location, e.g., locally in a storage unit of the recording device.

In Step 140, a transmission quality of video data at the recording device is adjusted based on the signal strength communicated by the wireless controller. If the signal strength is below a threshold, the captured video data is transformed into a lower quality video. For example, the frame rate or resolution of the video data can be reduced. If the signal strength is above the threshold, the captured video data is not transformed. If the signal strength is measured relative to latency (for example, if the latency is increasing as a transmitter moves further from the receiver), the transmitter can lower the data rate (i.e., lower frames and/or resolution of a video signal) to attempt to reduce the frequency of dropped packets and therefore reduce the perceived latency.

In Step 150, the captured video data is transmitted to the wireless controller for display by the display device. In Step 160, the wireless controller receives the transmitted video data and displays it using the display device. The display device can process the video data in any manner before displaying the video.

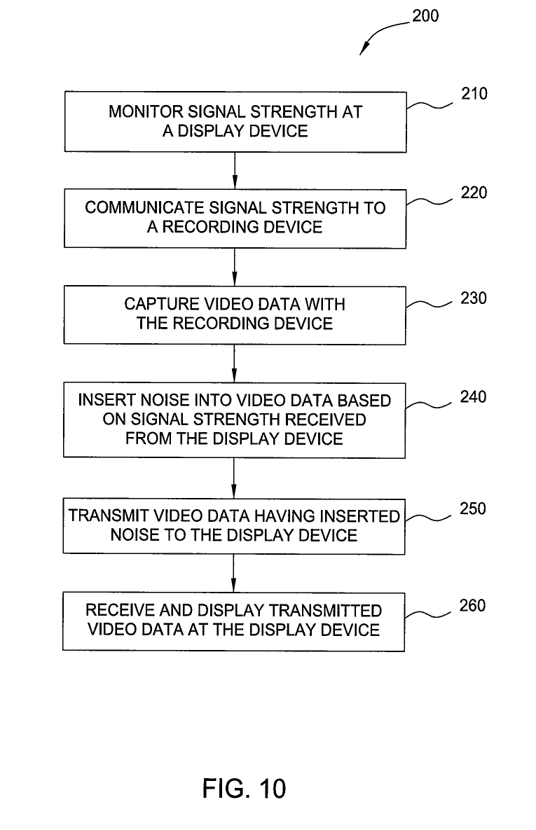

FIG. 10 is a flowchart that illustrates a method 200 of displaying a digital signal according to one embodiment. In particular, the illustrated method can insert noise in a transmitted digital video data to alert a receiver of reduced signal strength. The steps illustrated in FIG. 10 may be combined, modified, or deleted where appropriate. Additional steps may also be added to the example operation. Furthermore, the described steps may be performed in any suitable order.

Method 200 begins with Step 210. In Step 210, signal strength is measured or monitored at a display device using any appropriate signal strength detector. In the embodiment illustrated herein, the display device is part of a wireless controller configured to control a mobile device that captures video and transmits the captured video back to the wireless controller for display using the display device. In other embodiments, the. display device may be a part of a mobile or desktop computing device configured to control the mobile device. The signal strength that is measured may include transmission power, bandwidth, or latency. The RoboteX Avatar® II robot can measure the latency between the robot and the controller.

In Step 220, the measured signal strength is communicated to a recording device, which may include a video camera. One example is the RoboteX Avatar® II robot, which is able to capture video with a front-mounted drive camera or a 360-degree camera. In Step 230, video data is captured with the recording device at the native resolution of the recording device. The captured video data is stored in any appropriate location, e.g., locally in a storage unit of the recording device.

In Step 240, noise is inserted into the video data by the recording device based on the signal strength received from the display device. For example, white snow noise artifacts can be inserted into the image as the signal strength weakens. This would alert the viewer, user, or operator that the strength of the signal containing the video is weakening. An increased amount of noise can be inserted as the signal strength further decreases. Conversely, noise artifacts can be removed as the signal strength increases. Latency (as possibly measured in Step 210) could be minimized, but as a RoboteX Avatar® II robot operates progressively further from the RoboteX Avatar® II controller, the latency will increase. To effectively minimize the effects of an increased latency with a weaker signal strength (another possible side effect of the robot operating further from the controller), the transmitter can lower the frame rate, data rate, number of colors, or use another chosen technique for lowering a signal data rate to allow for smaller packets to be transmitted at a higher rate, reducing the likelihood of lost packets and/or an increase in latency.

In Step 250, the video data having inserted noise is transmitted to the display device. In Step 260, the wireless controller receives the transmitted video data and displays it using the display device. The display device can process the video data in any manner before displaying the video.

Alternatively, noise artifacts can be inserted at the side of the display device. In such an embodiment, the recording device sends the captured video data to the display device, and appropriate hardware and/or software at the side of the display device can insert the noise artifacts prior to displaying the video on the display device.

In certain other embodiments, signal strength or latency can be detected at the recording device and video quality can be adjusted or noise artifacts inserted, as described above, based on this signal strength or latency.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system, comprising:
first and second communication devices configured to communicate with one another over a wireless channel; and
a signal strength detection module configured to detect a signal strength of a signal transmitted over the wireless channel,
wherein the second communication device is configured to send digital data of a first quality to the first communication device if the signal strength is above a threshold and to send digital data of a second quality to the first communication device if the signal strength is below the threshold, the second quality being lower than the first quality.

2. The system of claim 1, wherein the digital data comprises digital video data.

3. The system of claim 2, wherein the first communication device comprises a controller for a robotic device and the second communication device comprises the robotic device.

4. The system of claim 3, wherein the first communication device further comprises a display to display the digital video data.

5. The system of claim 2, wherein the digital video data of the second quality has a lower frame rate than that of the digital video data of the first quality.

6. The system of claim 2, wherein the digital video data of the second quality has a lower display or color resolution than that of the digital video data of the first quality.

7. The system of claim 2, wherein the digital video data of the second quality has a lower contrast than that of the digital video data of the first quality.

8. The system of claim 2, wherein a first portion of the digital video data is transmitted at the first quality while a second portion of the digital video data is transmitted at the second quality, the first portion and the second portion being transmitted simultaneously.

9. The system of claim 1, wherein the data comprises digital audio data.

10. The system of claim 9, wherein the digital audio data of the second quality comprises a lower sampling frequency than the digital audio data of the first quality.

11. The system of claim 1, wherein the signal strength detection module detects the signal strength of the signal transmitted from the second communication device to the first communication device over the wireless channel, and the first communication device communicates the signal strength to the second communication device over the wireless channel.

12. The system of claim 1, wherein the signal strength detection module detects the signal strength of the signal transmitted from the first communication device to the second communication device over the wireless channel.

13. A system, comprising:
first and second communication devices configured to communicate with one another over a wireless channel, wherein at least one of the communication devices is configured to detect a latency of a signal transmitted over the wireless channel; and
the second communication device is configured to send digital data of a first quality to the first communication device if the latency is above a threshold and to send digital data of a second quality to the first communication device if the latency is below the threshold, the first quality being lower than the second quality.

14. The system of claim 13, wherein the first communication device comprises a controller for a robotic device and the second communication device comprises the robotic device.

15. The system of claim 13, wherein the digital data comprises digital video data, and the digital video data of the first quality has a lower frame rate than that of the digital video data of the second quality.

16. The system of claim 13, wherein a first portion of the digital data is transmitted at the first quality while a second portion of the digital data is transmitted at the second quality, the first portion and the second portion being transmitted simultaneously.

17. A system, comprising:
first and second communication devices configured to communicate with one another over a wireless channel; and
a signal strength detection module configured to detect a signal strength of a signal transmitted over the wireless channel;
wherein the second communication device is configured to insert noise into digital data to be transmitted to the first communication device, the amount of noise inserted into the digital data based in part on the signal strength.

18. The system of claim 17, wherein the amount of noise inserted into the digital data is inversely related to the signal strength.

19. The system of claim 18, wherein the data comprises digital video data, and the inserted noise reduces the quality of the digital video data.

20. A method of adjusting a quality of digital data transmitted over a wireless channel according to a signal strength of a signal transmitted over the wireless channel, comprising:
capturing digital data with a recording device;
transmitting digital data representative of the captured digital data over a wireless channel for reproduction by an output device, the transmitted digital data being of a first quality if the signal strength is above a threshold and of a second quality if the signal strength is below the threshold.

21. The method of claim 20, wherein the signal strength is measured as perceived latency, and wherein perceived latency includes signal latency and data packet drop rate.

22. The method of claim 20, wherein the captured digital data comprises digital video data, and wherein the transmitted digital data of the first quality has the same video quality as that of the captured digital data and the transmitted digital data of the second quality has a lower video quality than that of the captured digital data.

23. The method of claim 22, further comprising:
generating the digital data representative of the captured digital data to be of the second quality by reducing one of a frame rate, a display resolution, and a color resolution of the captured digital data.

24. A method of altering digital video data captured at a source and transmitting the altered digital video data to a destination over a wireless channel according to a signal strength of a signal transmitted over the wireless channel, comprising:
inserting noise into the digital video data captured at the source according to the signal strength, wherein an increased amount of noise is inserted if the signal strength decreases and a decreased amount of noise is inserted if the signal strength increases; and
transmitting the digital video data having the noise inserted therein to the destination.

25. The method of claim 24, further comprising adjusting a quality of the digital video data captured at the source according to the signal strength, wherein the transmitted digital data is a first quality if the signal strength is above a threshold and is a second quality if the signal strength is below the threshold.
